(19) United States
(12) Patent Application Publication
(10) Pub. No.: US 2011/0292040 A1
(43) Pub. Date: Dec. 1, 2011

(54) STEREOSCOPIC DISPLAY SYSTEM

(75) Inventor: Atsuhiro Chiba, Tokyo (JP)

(73) Assignee: Sony Corporation, Tokyo (JP)

(21) Appl. No.: 13/114,248

(22) Filed: May 24, 2011

(30) Foreign Application Priority Data
May 31, 2010 (JP) P2010-124615

(51) Int. Cl. G06T 15/00

(52) U.S. Cl. 345/419

(57) ABSTRACT

A stereoscopic display system includes: a display panel; a backlight; and shutter eyeglasses including a left-eye shutter and a right-eye shutter. The backlight is off during a period in which the left-eye and right-eye shutters both are open.

### BACKGROUND

This disclosure relates to a stereoscopic display system which uses shutter eyeglasses to perform stereoscopic displaying.

A stereoscopic display device of an eyeglasses type utilizes shutter eyeglasses, and presents separate images having parallax to both eyes of an observer, respectively, who wears the shutter eyeglasses to realize a stereoscopic vision. The shutter eyeglasses are used specially for the stereoscopic vision, and utilize liquid crystal shutters. For examples of the stereoscopic display devices of the eyeglasses type, reference is made to Japanese Patent Application Unexamined Publications No. H09-138384, No. 2000-36969, and No. 2003-45343. To realize the stereoscopic vision, two parallax images including an image for left eye and an image for right eye are used to allow the observer to see the different parallax images with his/her left and right eyes, respectively. The stereoscopic display device of the eyeglasses type realizes this stereoscopic vision by displaying the left-eye image and the right-eye image alternately in a time-divisional fashion on a two-dimensional display panel such as a liquid crystal display panel, and by turning, in synchronization with a display timing thereof, the liquid crystal shutters of the shutter eyeglasses ON and OFF (opening and closing control) alternately for the left eye and the right eye, for example.

### SUMMARY

The inventor/the inventors has/have found that not only light of a picture from a display but also light belonging to an external lighting source enter shutter eyeglasses depending on a viewing environment. A non-inverter type fluorescent lamp, some LED lightings, or the like used for the external lighting source blinks at a frequency twice the frequency of a commercial power supply. Thus, a flicker is caused when the blinking frequency of the external lighting source and an opening-closing frequency of liquid crystal shutters are in a certain relationship. The flicker is extremely disturbing to an observer, and causes visual fatigue. An intensity of the flicker is dependent also on the time during which the shutter is open, and the flicker is felt strongly by the observer particularly when the opening time of the shutter is short.

It is desirable to provide a stereoscopic display system capable of realizing a comfortable viewing environment for stereoscopic displaying.

A stereoscopic display system according to an embodiment of the technology includes: a display panel performing image displaying; a backlight irradiating light used for the image displaying toward the display panel; shutter eyeglasses including a left-eye shutter and a right-eye shutter that are controlled to be opened and closed independently of each other; a display control section allowing the display panel to alternately display a left-eye image and a right-eye image in a time-divisional fashion; a backlight control section controlling the backlight to be on and off; and a shutter control section controlling the left-eye shutter and the right-eye shutter to open and close in accordance with an image displayed on the display panel. The shutter control section allows the left-eye and right-eye shutters to establish a first period in which the left-eye and right-eye shutters both are open or closed, and the backlight control section allows the backlight to be off at least during the first period.

Advantageously, the backlight control section allows the backlight to be on at least during a period in which the left-eye and right-eye shutters both are closed.

A stereoscopic display system according to another embodiment of the technology includes: a display panel performing image displaying; a backlight irradiating light used for the image displaying toward the display panel; and shutter eyeglasses including a left-eye shutter and a right-eye shutter that are controlled to be opened and closed. The left-eye and right-eye shutters establish a period in which the left-eye and right-eye shutters both are open, and the backlight is turned off during the period in which the left-eye and right-eye shutters both are open.

A stereoscopic display system according to yet another embodiment of the technology includes: a display panel; a backlight; and shutter eyeglasses including a left-eye shutter and a right-eye shutter. The backlight is off during a period in which the left-eye and right-eye shutters both are open.

A stereoscopic display system according to still another embodiment of the technology includes: a display panel; a backlight; and shutter eyeglasses including a left-eye shutter and a right-eye shutter. The backlight is on during a period in which the left-eye and right-eye shutters both are closed.

In the stereoscopic display systems according to the embodiments of the technology, the left-eye and right-eye shutters are allowed to establish the period in which the left-eye and right-eye shutters both are open or closed, and the backlight is off at least during the period in which the left-eye and right-eye shutters both are open or closed. Advantageously, the backlight is allowed to be on at least during the period in which the left-eye and right-eye shutters both are closed.

According to the stereoscopic display systems of the embodiments of the technology, the left-eye and right-eye shutters are allowed to establish the period in which the left-eye and right-eye shutters both are open or closed, and the backlight is off at least during the period in which the left-eye and right-eye shutters both are open or closed. This makes it possible to allow periods during which the respective left-eye shutter and the right-eye shutter are open to be long. Thereby, it is possible to reduce a flicker caused by an interference of a blinking frequency of an external lighting source and an opening-closing frequency of the shutter eyeglasses. Also, allowing of the backlight to be on at least during the period in which the left-eye and right-eye shutters both are closed makes it possible to allow a period during which the backlight is lighted to be long. Thereby, it is possible to suppress a generation of a crosstalk caused by a decrease in temperature of the display panel. Thus, the control on the lighting state of the backlight and the opening-closing control of the respective left-eye shutter and the right-eye shutter of the shutter eyeglasses are optimized. Therefore, it is possible to realize a comfortable viewing environment for stereoscopic displaying.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating an example of a configuration of a stereoscopic display system according to a first embodiment of the technology.

FIG. 2 is a timing chart schematically illustrating response timings of respective elements in the stereoscopic display system according to the first embodiment, wherein (A) schematically illustrates the response timing of image displaying in a liquid crystal display panel, (B) schematically illustrates the lighting timing of a backlight, (C) schematically illustrates the opening-closing timing of a left-eye shutter, and (D) schematically illustrates the opening-closing timing of a right-eye shutter.

FIG. 3 is a timing chart schematically illustrating response timings of respective elements in a stereoscopic display system according to a first modification of the first embodiment, wherein (A) schematically illustrates the response timing of the image displaying in the liquid crystal display panel, (B) schematically illustrates the lighting timing of the backlight, (C) schematically illustrates the opening-closing timing of the left-eye shutter, and (D) schematically illustrates the opening-closing timing of the right-eye shutter.

FIG. 4 is a timing chart schematically illustrating response timings of respective elements in a stereoscopic display system according to a second modification of the first embodiment, wherein (A) schematically illustrates the response timing of the image displaying in the liquid crystal display panel, (B) schematically illustrates the lighting timing of the backlight, (C) schematically illustrates the opening-closing timing of the left-eye shutter, and (D) schematically illustrates the opening-closing timing of the right-eye shutter.

FIG. 5 is a timing chart schematically illustrating response timings of respective elements in a stereoscopic display system according to a second embodiment of the technology, wherein (A) schematically illustrates the response timing of the image displaying in the liquid crystal display panel, (B) schematically illustrates the lighting timing of the backlight, (C) schematically illustrates the opening-closing timing of the left-eye shutter, and (D) schematically illustrates the opening-closing timing of the right-eye shutter.

FIG. 6 is a timing chart schematically illustrating response timings of respective elements in a stereoscopic display system according to a first modification of the second embodiment, wherein (A) schematically illustrates the response timing of the image displaying in the liquid crystal display panel, (B) schematically illustrates the lighting timing of the backlight, (C) schematically illustrates the opening-closing timing of the left-eye shutter, and (D) schematically illustrates the opening-closing timing of the right-eye shutter.

FIG. 7 is a timing chart schematically illustrating response timings of respective elements in a stereoscopic display system according to a second modification of the second embodiment, wherein (A) schematically illustrates the response timing of the image displaying in the liquid crystal display panel, (B) schematically illustrates the lighting timing of the backlight, (C) schematically illustrates the opening-closing timing of the left-eye shutter, and (D) schematically illustrates the opening-closing timing of the right-eye shutter.

FIG. 8 is a timing chart schematically illustrating response timings of respective elements in a stereoscopic display system according to a first comparative example, wherein (A) schematically illustrates the response timing of image displaying in a liquid crystal display panel, (B) schematically illustrates the lighting timing of a backlight, and (C) schematically illustrates the opening-closing timing of a left-eye shutter and that of a right-eye shutter.

FIG. 9 is a timing chart schematically illustrating response timings of respective elements in a stereoscopic display system according to a second comparative example, wherein (A) schematically illustrates the response timing of image displaying in the liquid crystal display panel, (B) schematically illustrates the lighting timing of the backlight, and (C) schematically illustrates the opening-closing timing of the left-eye shutter and that of the right-eye shutter.

### DETAILED DESCRIPTION

In the following, some embodiments of the technology will be described in detail with reference to the accompanying drawings.

Before describing the embodiments and modifications of the technology, description will be given on comparative examples first.

### COMPARATIVE EXAMPLES

In general, a liquid crystal display panel is a display device of a line-sequential type that overwrites an image on a line-by-line basis, and a response speed of liquid crystals is relatively slow. Thus, a delay is likely to occur during from application of a drive signal to a time point in which the image is completely switched over throughout the entire display screen. As a result, a crosstalk may be caused, which is a phenomenon in which left and the right parallax images are not switched over completely from one to the other and thus the left and the right parallax images are displayed in a mixed fashion, when time-divisionally displaying the respective left and right parallax images. Under such displaying circumstances, when the left and right of shutter eyeglasses are switched over from one to the other, a part of the right-eye image may enter or leak into a left eye, or a part of the left-eye image may enter or leak into a right eye. To address this, a method may be contemplated, which increases a drive frequency of the liquid crystal display panel to time-divisionally write the respective left and the right parallax images twice. For example, the method may perform image displaying in order of “LLRR” where “L” is the left-eye image and “R” is the right-eye image. By successively writing the same image twice (displaying the same image twice), the switching over of the left and the right parallax images is improved as compared with a case where the left and the right parallax images are alternately displayed one at a time. Further, by turning liquid crystal shutters of the shutter eyeglasses ON and OFF at the timing in which the left and the right parallax images have completely switched over from one to the other throughout the entire screen, the crosstalk is improved.

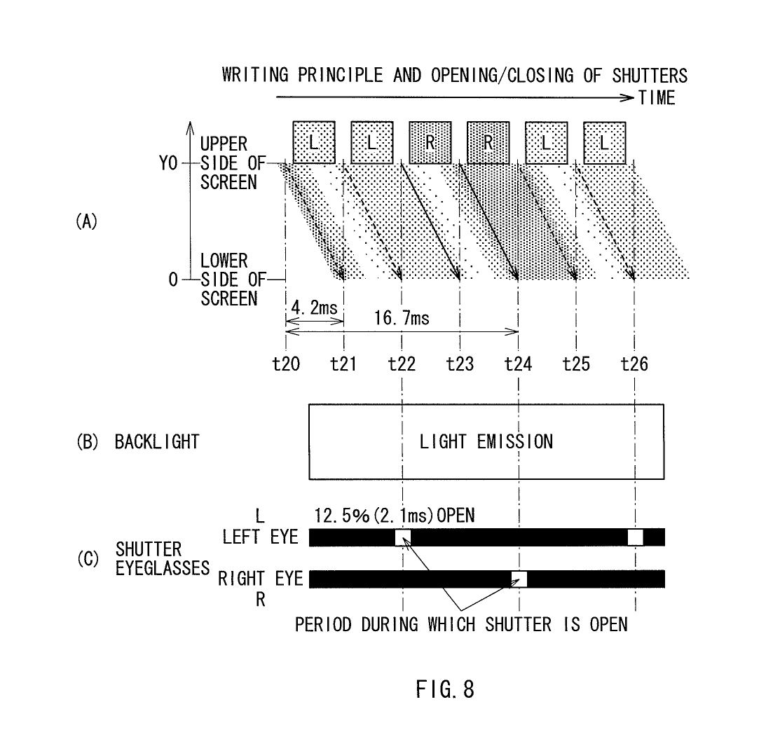

FIG. 8 is a timing chart schematically illustrating response timings of respective elements in a stereoscopic display system according to a first comparative example that utilizes the twice-writing scheme described before. In FIG. 8, (A) schematically illustrates the response timing of image displaying in the liquid crystal display panel, (B) schematically illustrates the lighting timing of a backlight, and (C) schematically illustrates the opening-closing timing of the left-eye shutter and that of the right-eye shutter of the shutter eyeglasses.

Referring to (A) of FIG. 8, each of the right-eye image R and the left-eye image L is displayed on the liquid crystal display panel at a drive frequency of 240 Hz, according to the first comparative example. In (A) of FIG. 8, the time during which the right-eye image R or the left-eye image L is displayed by a single writing is 4.2 msec ( 1/240 Hz=4.2 msec). Also, the left image data and the right image data are written in order of “LLRR” within a period of 16.7 msec ( 1/60 Hz=16.7 msec).

In (A) of FIG. 8, a change in luminance with an elapse of time in each position in a vertical direction from a lower side (Y=0) to an upper side (Y=Y0) of the screen of the liquid crystal display panel, is illustrated. In the first comparative example, the backlight is constantly lighted (emitted) irrespective of a state of displaying of the images on the liquid crystal display panel as illustrated in (B) of FIG. 8.

As illustrated in (A) of FIG. 8, in the upper side (Y=Y0) of the screen, the left-eye image L is written during a period of 4.2 msec from time t20 to time t21, following which the left-eye image L is written again during a period of 4.2 msec from the time t21 to time t22, for example. Then, the right-eye image R is written after the left-eye image L has been written twice. The right-eye image R is likewise written during, in the upper side (Y=Y0) of the screen, a period of 4.2 msec from the time t22 to time t23, following which the right-eye image R is written again during a period of 4.2 msec from the time t23 to time t24, for example.

In general, the response time of the liquid crystal display panel is relatively slow, and thus a luminance in each pixel does not reach a desired luminance level when the writing time is short. As a result, when the drive frequency is increased to alternately write the right-eye image R and the left-eye image L, the time for each writing becomes short, and the luminance reaches the desired luminance level only after the completion of the first writing. Hence, there is no timing in which the luminance in the upper side and that in the lower side of the screen both reach the desired luminance levels.

In contrast, in the comparative example illustrated in (A) of FIG. 8, the right-eye image R and the left-eye image L are each written twice. Thus, since the same image has been already written at the first time, the desired luminance level is held at the time when the second writing is performed. Hence, a state in which the luminance in the upper side and that in the lower side of the screen have both reached the desired luminance levels is realized for a predetermined period. For example, the luminance of the left-eye image L has reached the desired luminance level throughout the entire screen from the upper side to the lower side of the screen at the time t22 in (A) of FIG. 8. Consequently, as illustrated in (C) of FIG. 8, by allowing the left-eye shutter to open only for a predetermined period (for example, 2.1 msec) centered around the time t22, only the left-eye image L is visually recognized by the left eye of a user. Likewise, in (A) of FIG. 8, the luminance of the right-eye image R has reached the desired luminance level throughout the entire screen from the upper side to the lower side of the screen at the time t24. Consequently, as illustrated in (C) of FIG. 8, by allowing the right-eye shutter to open only for a predetermined period (for example, 2.1 msec) centered around the time t24, only the right-eye image R is visually recognized by the right eye of the user.

Thus, in the first comparative example illustrated in (A) to (C) of FIG. 8, the right-eye image R and the left-eye image L are each written twice, to provide the predetermined period (for example, 2.1 msec) during which the luminance of the left-eye image L or that of the right-eye image R has reached the desired level throughout the entire screen. Further, only the shutter is allowed to open during that predetermined period in which the luminance of the left-eye image L or that of the right-eye image R has reached the desired level, to suppress the crosstalk.

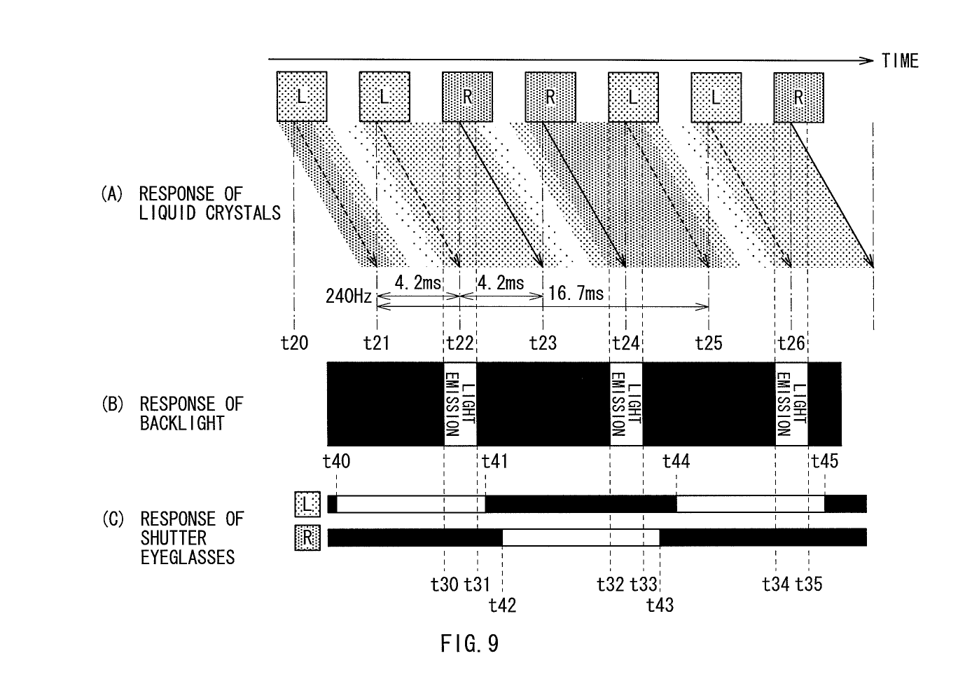

FIG. 9 is a timing chart schematically illustrating response timings of respective elements in a stereoscopic display system according to a second comparative example that utilizes the twice-writing scheme described above. As in FIG. 8, (A) of FIG. 9 schematically illustrates the response timing of image displaying in the liquid crystal display panel, (B) schematically illustrates the lighting timing of the backlight, and (C) schematically illustrates the opening-closing timing of the left-eye shutter and that of the right-eye shutter of the shutter eyeglasses.

In the first comparative example described before, the backlight is lighted constantly as illustrated in (B) of FIG. 8. In the second comparative example, the backlight is turned ON and OFF to control a state of lighting thereof in synchronization with the opening and the closing of the liquid crystal shutters, as illustrated in (B) and (C) of FIG. 9. Incidentally, the state of displaying of the liquid crystal display panel in (A) of FIG. 9 is the same as that in (A) of FIG. 8.

In the second comparative example, the left-eye shutter opens, for example, between the time t40 and the time t41 as illustrated in (C) of FIG. 9. Also, the backlight is lighted in synchronization with the opening of the left-eye shutter between the time t30 and the time t31 as illustrated in (B) of FIG. 9. The time t30 to the time t31 is a predetermined period (for example, 2.1 msec) centered around the time t22. The predetermined period that is centered around the time t22 is a period in which the luminance of the left-eye image L has reached the desired luminance level throughout the entire screen from the upper side to the lower side of the screen, as in the comparative example illustrated in (A) of FIG. 8. As can be seen from (B) and (C) of FIG. 9, an interval between the time t40 and the time t41 during which the left-eye shutter is open is set sufficiently longer than an interval between the time t30 and the time t31 during which the backlight is lighted for the left eye.

As for the right eye, the right-eye shutter likewise opens, for example, between the time t42 and the time t43. The backlight is also lighted in synchronization with the opening of the right-eye shutter between the time t32 and the time t33. The time t32 to the time t33 is a predetermined period (for example, 2.1 msec) centered around the time t24. The predetermined period that is centered around the time t24 is a period in which the luminance of the right-eye image R has reached the desired luminance level throughout the entire screen from the upper side to the lower side of the screen, as in the comparative example illustrated in (A) of FIG. 8. As can be seen from (B) and (C) of FIG. 9, an interval between the time t42 and the time t43 during which the right-eye shutter is open is set sufficiently longer than an interval between the time t32 and the time t33 during which the backlight is lighted for the right eye.

Thus, in the second comparative example illustrated in (A) to (C) of FIG. 9, the time in which the shutter is open is made longer than that in the first comparative example described above, while the backlight is lighted only during the predetermined period (for example, 2.1 msec) in which the luminance of the left-eye image L or the right-eye image R has reached the desired level throughout the entire screen. Also, the backlight is turned off in periods other than the predetermined period. The second comparative example thereby suppresses the crosstalk.

In the stereoscopic display systems according to the first and the second comparative examples described above, not only light of a picture from the display but also light belonging to an external lighting source enter the shutter eyeglasses depending on a viewing environment. A non-inverter type fluorescent lamp, some LED lightings, or the like used for the external lighting source blinks at a frequency twice the frequency of a commercial power supply. Thus, a flicker is caused when the blinking frequency of the external lighting source and an opening-closing frequency of the liquid crystal shutters are in a certain relationship. The flicker is extremely disturbing to an observer, and causes visual fatigue. An intensity of the flicker is dependent also on the time during which the shutter is open, and the flicker is felt strongly by the observer particularly when the opening time of the shutter is short. Hence, the first comparative example illustrated in (A) to (C) of FIG. 8 may be disadvantageous in that the flicker caused by the interference with the external lighting source becomes strong, since the opening time of the shutter is short. In the second comparative example illustrated in (A) to (C) of FIG. 9, the opening time of the shutter is long, and thus the flicker is alleviated. However, since the backlight is lighted only in some periods, a temperature of the liquid crystal display panel becomes lower than that in a case where the backlight is constantly lighted like in the first comparative example. This in turn decreases a responsiveness of liquid crystals in the liquid crystal display panel, and may generate the crosstalk.

### First Embodiment

### System Configuration

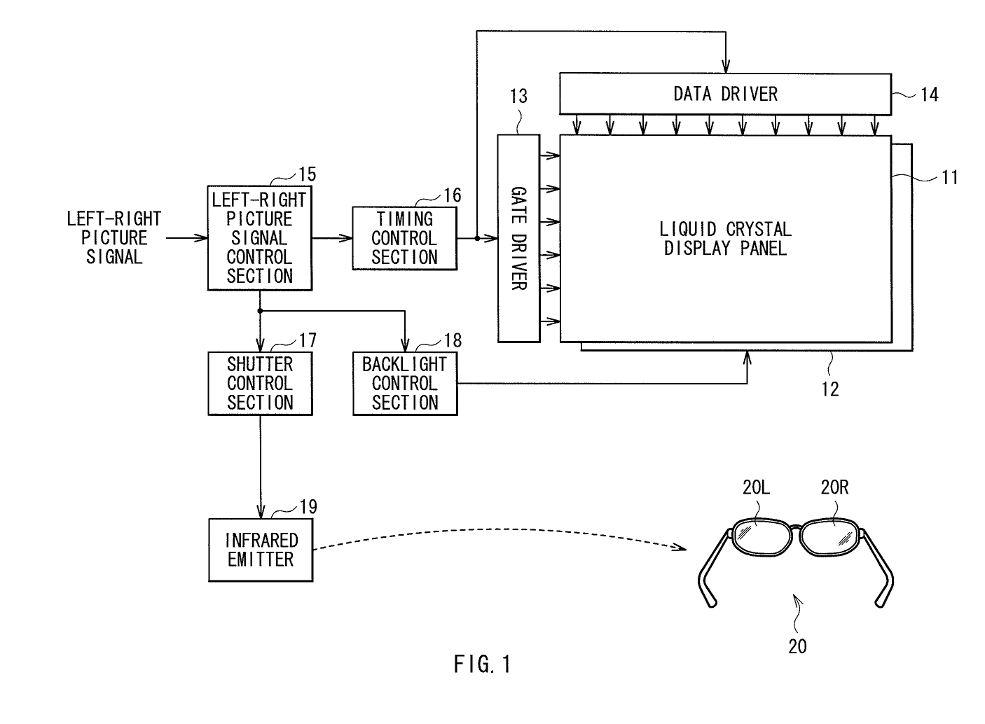

FIG. 1 illustrates an example of a configuration of a stereoscopic display system according to a first embodiment of the technology. The stereoscopic display system is provided with: a liquid crystal display panel 11 that performs displaying of an image; a backlight 12 that irradiates light used for the image displaying toward the liquid crystal display panel 11; and shutter eyeglasses 20 including a left-eye shutter 20L and a right-eye shutter 20R that are controlled to be open and closed independently of each other. The stereoscopic display system is further provided with a gate driver 13, a data driver 14, a left-right picture signal control section 15, a timing control section 16, a shutter control section 17, a backlight control section 18, and an infrared emitter 19.

The liquid crystal display panel 11 is a display panel of a transmissive type that controls using liquid crystal molecules a state of passage of the light irradiated from the backlight 12, to perform the image displaying. The liquid crystal display panel 11 has an unillustrated configuration including: a pixel electrode substrate; a transparent opposed substrate disposed to face the pixel electrode substrate; and a liquid crystal layer inserted and sealed between the pixel electrode substrate and the opposed substrate. A surface of the opposed substrate that faces the liquid crystal layer is uniformly formed with a common electrode, for example. A surface of the pixel electrode substrate that faces the liquid crystal layer is formed with a plurality of pixel electrodes, which are arranged in matrix. The pixel electrodes may include pixels for red (R), pixels for green (G), and pixels for blue (B), although the number of colors and the types of colors are not limited thereto. The common electrode and the pixel electrodes each may be a transmissive electrode formed by a material such as indium-tin-oxide (ITO) or other suitable transmissive material. The pixel electrode is so configured that a state of voltage application is controlled, for example, by a thin-film transistor (TFT) based on drive signals from the gate driver 13 and the data driver 14.

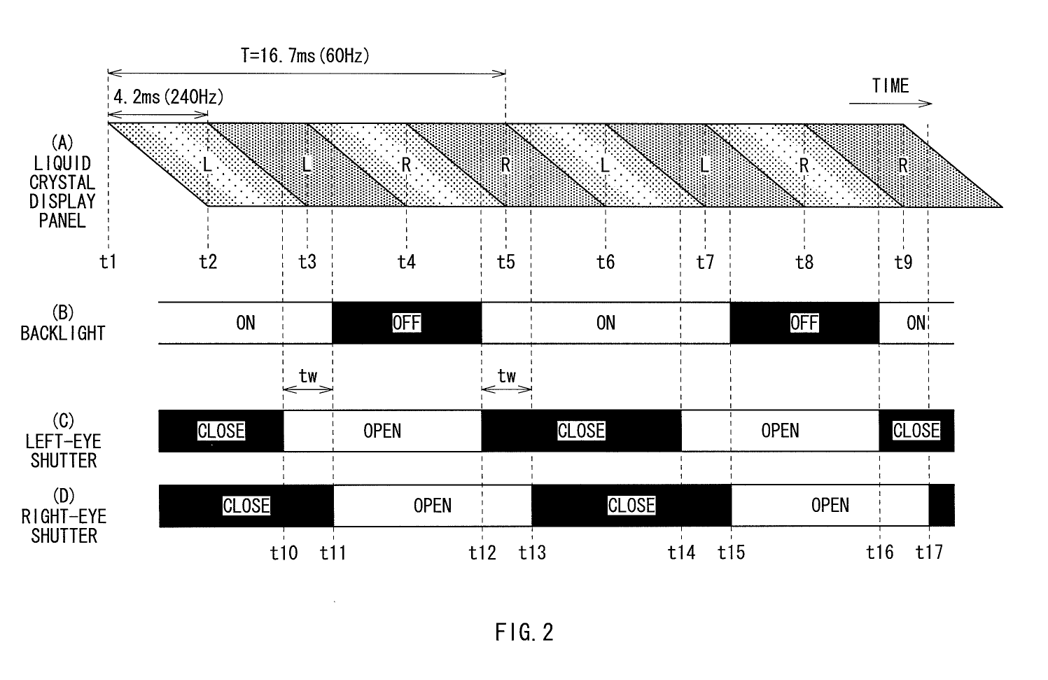

The left-right picture signal control section 15 and the timing control section 16 serve to realize a function as a “display control section” that alternately displays a left-eye image L and a right-eye image R in a time-divisional fashion on the liquid crystal display panel 11. The display control section performs a control of successively displaying the same left-eye image L and the same right-eye image R respectively twice or more times, and alternately displaying the plurality of consecutive left-eye images L and the plurality of consecutive right-eye images R, on the liquid crystal display panel 11. In this embodiment, description will be given with reference to an example where a scheme in which the same image is written twice consecutively (displayed twice) is performed, i.e., where the image displaying is performed in order of “LLRR”, as illustrated in (A) of FIG. 2.

The left-right picture signal control section 15 is so configured that left-right picture signal for displaying the right-eye image R and the left-eye image L is inputted. The left-right picture signal control section 15 alternately outputs the left-right picture signal, in order to display the right-eye image R and the left-eye image L alternately on the liquid crystal display panel 11. Also, the left-right picture signal control section 15 so performs, based on the inputted left-right picture signal, a conversion on each of the right-eye picture signal and the left-eye picture signal that two same signals continue for each of those picture signals, in order to perform later-described twice writing of the images as illustrated in (A) of FIG. 2.

The left-right picture signal control section 15 is further configured to send to each of the backlight control section 18 and the shutter control section 17 a timing signal indicating a timing of switching over the left-eye picture signals and the right-eye picture signals, both of which have been so converted that two left-eye picture signals continue and that the two-right-eye picture signals continue.

The timing control section 16 is so configured that the right-eye picture signal and the left-eye picture signal, both of which have been converted in the left-right picture signal control section 15, are inputted. The timing control section 16 converts the inputted right-eye picture signal and the inputted left-eye picture signal into signals for input to the liquid crystal display panel 11, and generates pulse signals that are used in operations of the gate driver 13 and the data driver 14. The signals converted in the timing control section 16 are inputted respectively to the gate driver 13 and the data driver 14.

Each of the gate driver 13 and the data driver 14 receives the pulse signal generated in the timing control section 16, and causes each of the pixels in the liquid crystal display panel 11 to emit light (or applies a drive voltage to each of the pixel electrodes so that the light from the backlight 12 is allowed to pass) based on the signal inputted. Thereby, a picture is displayed on the liquid crystal display panel 11.

The backlight control section 18 controls a lighting state of the backlight 12. The backlight control section 18 outputs, based on the timing signal inputted from the left-right picture signal control section 15, a blinking timing signal for blinking the backlight 12. As illustrated in (B), (C), and (D) of FIG. 2 to which the reference is made later in detail, the backlight control section 18 performs a control of turning off the backlight 12, at least during a period (a first period) in which the left-eye shutter 20L and the right-eye shutter 20R of the shutter eyeglasses 20 are both in an open state (for example, a period between the time t11 and the time t12 in (C) and (D) of FIG. 2). Also, the backlight control section 18 performs a control of turning on the backlight 12, at least during a period (the first period) in which the left-eye shutter 20L and the right-eye shutter 20R are both in a closed state (for example, a period between the time t13 and the time t14 in (C) and (D) of FIG. 2). Further, the backlight control section 18 performs a control of turning on the backlight 12, also during a period (a second period) in which only the left-eye shutter 20L is in the open state (for example, a period between the time t10 and the time t11 in (C) of FIG. 2), and during a period (a third period) in which only the right-eye shutter 20R is in the open state (for example, a period between the time t12 and the time t13 in (D) of FIG. 2).

The backlight 12 is configured by a light source on which the control of turning on and off the light is performable at high speed and in which an afterglow characteristic is superior, such as light-emitting diodes (LEDs). An afterglow characteristic of a fluorescent material used for the backlight 12 may be set to be equal among the three colors of R, G, and B, for example. The backlight 12 is so configured that the turning on and off of the light is performed based on the blinking timing signal sent from the backlight control section 18.

The shutter control section 17 controls the open/closed state of the left-eye shutter 20L and that of the right-eye shutter 20R in accordance with the displaying state of the image displayed on the liquid crystal display panel 11. As illustrated in (C) and (D) of FIG. 2 to which the reference is made later in detail, the shutter control section 17 so controls the open/closed states of the left-eye shutter 20L and the right-eye shutter 20R, that a period during which the open/closed state of the left-eye shutter 20L and that of the right-eye shutter 20R are the same is included. More specifically, the shutter control section 17 so controls, in accordance with the displaying state of the image displayed on the liquid crystal display panel 11, the open/closed states of the left-eye shutter 20L and the right-eye shutter 20R that: a period during which only the left-eye shutter 20L is in the open state (the second period); a period during which only the right-eye shutter 20R is in the open state (the third period); a period during which both the left-eye shutter 20L and the right-eye shutter 20R are in the open state (the first period); and a period during which both the left-eye shutter 20L and the right-eye shutter 20R are in the closed state (the first period), are included or established.

The shutter control section 17 sends, based on the timing signal sent from the left-right picture signal control section 15, an opening-closing timing signal to the infrared emitter 19. The opening-closing timing signal serves to open and close the left-eye shutter 20L and the right-eye shutter 20R of the shutter eyeglasses 20. The infrared emitter 19 transmits the opening-closing timing signal to the shutter eyeglasses 20 using an infrared communication.

The shutter eyeglasses 20 are provided with the left-eye shutter 20L and the right-eye shutter 20R each utilizing a liquid crystal shutter. The shutter eyeglasses 20 are further provided with a receiver for the infrared communication. The shutter eyeglasses 20 perform, based on the opening-closing timing signal received from the shutter control section 17 through the infrared emitter 19, opening-closing operations of the left-eye shutter 20L and the right-eye shutter 20R.

### [Displaying Operation]

In the following, operations associated with the displaying of the stereoscopic displaying system according to the first embodiment will be described with reference to (A) to (D) of FIG. 2. In particular, control operations on respective timings including a response timing of the liquid crystal display panel 11 ((A) of FIG. 2), a blinking timing (a lighting timing) of the backlight 12 ((B) of FIG. 2), and opening-closing timings of the shutter eyeglasses 20 ((C) and (D) of FIG. 2) will be described.

As in (A) of FIG. 8 according to the comparative example, (A) of FIG. 2 illustrates that the displaying is line-sequentially performed from an upper side to a lower side of a screen of the liquid crystal display panel 11, and that the luminance changes with an elapse of time in each position in a vertical direction from the upper side to the lower side of the screen. (B) of FIG. 2 schematically illustrates the lighting timing of the backlight 12. (C) of FIG. 2 schematically illustrates the opening-closing timing of the left-eye shutter 20L in the shutter eyeglasses 20. (D) of FIG. 2 schematically illustrates the opening-closing timing of the right-eye shutter 20R in the shutter eyeglasses 20.

It is to be noted that, from the viewpoint of an observer, the observer recognizes that the image displaying is performed on the liquid crystal display panel 11, when the backlight 12 is in a lighted state and also the liquid crystal display panel 11 is in a displayed state (a state in which writing of valid display data is performed). Conversely, from the viewpoint of the observer, the observer recognizes a period during which the image displaying is not performed on the liquid crystal display panel 11, when the backlight 12 is in an off state even when the liquid crystal display panel 11 is in the displayed state. It can be further said that, for the observer, a state of the image displaying changes also depending on the open/closed states of the shutter eyeglasses 20. Therefore, as used herein, the wordings such as “to display the image on the liquid crystal display panel 11” refer to a state in which, as a state of operation of the liquid crystal display panel 11 alone, the liquid crystal display panel 11 performs the image displaying (a state in which the writing of the valid display data is performed), irrespective of whether or not the image is displayed in terms of or as viewed from the observer. In this embodiment, the left-right picture signal control section 15 and the timing control section 16 both serving as the display control section perform a control of displaying the image on the liquid crystal display panel 11 constantly irrespective of the open/closed states of the shutter eyeglasses 20, including the period during which both the left-eye shutter 20L and the right-eye shutter 20R are in the open state. In other words, the display control section allows the liquid crystal display panel 11 to display the image constantly during a period including the period (the first period) in which the left-eye and right-eye shutters 20L and 20R both are open or closed, whether the left-eye and right-eye shutters 20L and 20R are open or closed. As used herein, the wordings such as “display the image constantly” mean that there is no insertion or substantially no insertion of invalid data such as a so-called black insertion, i.e., valid data is displayed at any time or substantially at any time.

First, description will be given on a displaying operation in the liquid crystal display panel 11 illustrated in (A) of FIG. 2. The first embodiment adopts a scheme, in which a drive frequency of the liquid crystal display panel 11 is increased and in which one frame of each left image and right image is displayed twice (written twice) on the liquid crystal display panel 11, in order to improve factors such as: the generation of the crosstalk caused by the insufficient response speed of the liquid crystals; and insufficient luminance in the liquid crystal display panel 11. As illustrated in (A) of FIG. 2, the liquid crystal display panel 11 displays each of the right-eye image R and the left-eye image L at the drive frequency of 240 Hz, and the time during which the right-eye image R or the left-eye image L is displayed by a single writing of the display data is 4.2 msec ( 1/240 Hz=4.2 msec). Also, the left image data and the right image data are written in order of “LLRR” within a period of 16.7 msec ( 1/60 Hz=16.7 msec).

As illustrated in (A) of FIG. 2, in the upper side of the screen, the left-eye image L is written during a period of 4.2 msec from time t1 to time t2, following which the left-eye image L is written again during a period of 4.2 msec from the time t2 to time t3, for example. The left-eye image L written between the time t1 and the time t2 and that written between the time t2 and the time t3 are basically the same image, although in one embodiment, those left-eye images L may be different due to an adjustment such as an overdrive process. Also, in one embodiment, a predetermined blank period may be provided between the left-eye image L written for the first time and the left-eye image L written for the second time.

Then, the right-eye image R is written after the left-eye image L has been written twice. The right-eye image R is likewise written during, in the upper side of the screen, a period of 4.2 msec from the time t3 to time t4, following which the right-eye image R is written again during a period of 4.2 msec from the time t4 to time t5, for example. The right-eye image R written between the time t3 and the time t4 and that written between the time t4 and the time t5 are basically the same image, although in one embodiment, those right-eye images R may be different due to an adjustment such as the overdrive process. Also, in one embodiment, a predetermined blank period may be provided between the right-eye image R written for the first time and the right-eye image R written for the second time, or between the left-eye image L and the right-eye image R.

In general, response time of a liquid crystal display panel is relatively slow, and thus luminance in each pixel does not reach a desired luminance level when writing time is short. As a result, when a drive frequency is increased to alternately write a right-eye image R and a left-eye image L, the time for each writing (=4.2 msec) becomes short, and the luminance reaches the desired luminance level only after the completion of the first writing. Hence, there is no timing in which the luminance in the upper side and that in the lower side of the screen both reach the desired luminance levels. In contrast, according to the first embodiment illustrated in (A) of FIG. 2, the right-eye image R and the left-eye image L are each written twice. Thus, the desired luminance level is held at the time when the second writing is performed. Hence, it is possible to realize the state in which the luminance in the upper side and that in the lower side of the screen have both reached the desired luminance levels.

For example, in (A) of FIG. 2, the luminance of the left-eye image L has reached the desired luminance level throughout the entire screen from the upper side to the lower side of the screen at the time t3. Likewise, the luminance of the right-eye image R has reached the desired luminance level throughout the entire screen from the upper side to the lower side of the screen at the time t5, for example. Thus, by allowing the observer to see with his/her left eye only a predetermined period tw (equals to a period from t10 to t11 which is 2.1 msec, for example) that includes the time t3, and by allowing the observer to see with his/her right eye only a predetermined period tw (equals to a period from t12 to t13 which is 2.1 msec, for example) that includes the time t5, it is possible to suppress the generation of the crosstalk. It is to be noted that, since the crosstalk and the luminance are in a trade-off relationship, the periods for allowing the observer to see are set suitably or optionally depending on which one of the crosstalk and the luminance should be given priority to.

Next, operations of the backlight 12 and the shutter eyeglasses 20 illustrated in (B) to (D) of FIG. 2 will be described. In this embodiment, the description is given on an assumption that transient characteristics at the time of the opening and the closing of the liquid crystal shutters in the shutter eyeglasses 20 are negligible. Also, the control of turning on and off the backlight 12 is performed by the backlight control section 18, and the open/closed states of the shutter eyeglasses 20 are controlled by the shutter control section 17 as described above.

The backlight 12 is so controlled that the backlight 12 is turned off only during a period in which the images are sequentially rewritten from the left-eye image L to the right-eye image R, i.e., only during a period from the time t11 to the time t12 and during a period from the time t15 to the time t16 in the periods illustrated in (B) of FIG. 2 for example, and that the backlight 12 is turned on in periods other than the period in which the sequential rewriting from the left-eye image L to the right-eye image R is performed (for example, a period from the time t12 to the time t15).

Also, the left-eye shutter 20L is so controlled that the left-eye shutter 20L is in the closed state during a period in which the right-eye image R is displayed throughout the entire liquid crystal display panel 11 and also during a period in which the images are sequentially rewritten from the right-eye image R to the left-eye image L (i.e., during a period from the time t12 to the time t14 in the periods illustrated in (C) of FIG. 2 for example), and that the left-eye shutter 20L is in the open state in periods other than those periods (for example, periods from the time t10 to t12 and from time t14 to t16).

On the other hand, the right-eye shutter 20R is so controlled that the right-eye shutter 20R is in the closed state during a period in which the left-eye image L is displayed throughout the entire liquid crystal display panel 11 and also during a period in which the first left-eye image L is written (i.e., during a period from the time t13 to the time t15 in the periods illustrated in (D) of FIG. 2 for example), and that the right-eye shutter 20R is in the open state in periods other than those periods (for example, periods from the time t11 to t13 and from time t15 to t17).

Here, when paying attention to a phase difference in the opening-closing timing between the left-eye shutter 20L and the right-eye shutter 20R, the phase difference is equivalent to a period of “T/2” where a cycle in which an image per eye is displayed (a time interval of displaying the left-eye image L or the right-eye image R on the display panel 11) is “T” (equals a period of 60 Hz) in the comparative examples illustrated in (C) of FIG. 8 and (C) of FIG. 9, for example. In contrast, according to the first embodiment illustrated in (C) and (D) of FIG. 2, the phase difference is set to the period tw during which the left-eye image L or the right-eye image R is displayed throughout the entire liquid crystal display panel 11 (for example, 2.1 msec, i.e., a cycle of “T/8”). Also, in the first embodiment, the backlight 12 is turned off during the period in which both the left-eye shutter 20L and the right-eye shutter 20R are open (for example, the period from the time t11 to the time t12), and the backlight 12 is turned on during the period in which both the left-eye shutter 20L and the right-eye shutter 20R are closed (for example, the period from the time t13 to the time t14). Thus, a proportion of time during which the backlight 12 is lighted is larger than that of the scheme according to the comparative example illustrated in FIG. 9 where the backlight is turned off in all of the periods in which the images are rewritten. Hence, it is possible to increase a temperature of the liquid crystal display panel 11 by heat generation of the backlight 12, and to improve the responsiveness of the liquid crystals.

According to the stereoscopic display system of the first embodiment described above, the open/closed states of the shutters are controlled to include the period during which the open/closed state of the left-eye shutter 20L and that of the right-eye shutter 20R are the same, and the control of turning on the backlight 12 is performed at least during the period in which the left-eye shutter 20L and the right-eye shutter 20R are both in the closed state. In other words, the left-eye and right-eye shutters 20L and 20R are allowed to establish the period in which the left-eye and right-eye shutters 20L and 20R both are open or closed, and the backlight 12 is allowed to be on at least during the period in which the left-eye and right-eye shutters 20L and 20R both are closed. This makes it possible to allow the period during which the backlight 12 is lighted to be long. Thereby, it is possible to suppress the decrease in the responsiveness of the liquid crystals caused by the temperature decrease in the liquid crystal display panel 11, and to suppress the generation of the crosstalk. Also, the control of turning off the backlight 12 is performed during the period in which the left-eye shutter 20L and the right-eye shutter 20R are both in the open state. In other words, the left-eye and right-eye shutters 20L and 20R are allowed to establish the period in which the left-eye and right-eye shutters 20L and 20R both are open or closed, and the backlight 12 is allowed to be off at least during that period. This makes it possible to allow the periods during which the respective left-eye shutter 20L and the right-eye shutter 20R are in the open state to be long. Thereby, it is possible to reduce the flicker caused by the interference of the blinking frequency of the external lighting source and the opening-closing frequency of the shutter eyeglasses. Thus, the displaying scheme of successively writing the same image twice on the liquid crystal display panel 11 is adopted, and the control of the lighting state of the backlight 12 as well as the opening-closing control of the respective left-eye shutter 20L and the right-eye shutter 20R of the shutter eyeglasses 20 are optimized. Therefore, it is possible to realize a comfortable viewing environment for stereoscopic displaying.

### First Modification of First Embodiment

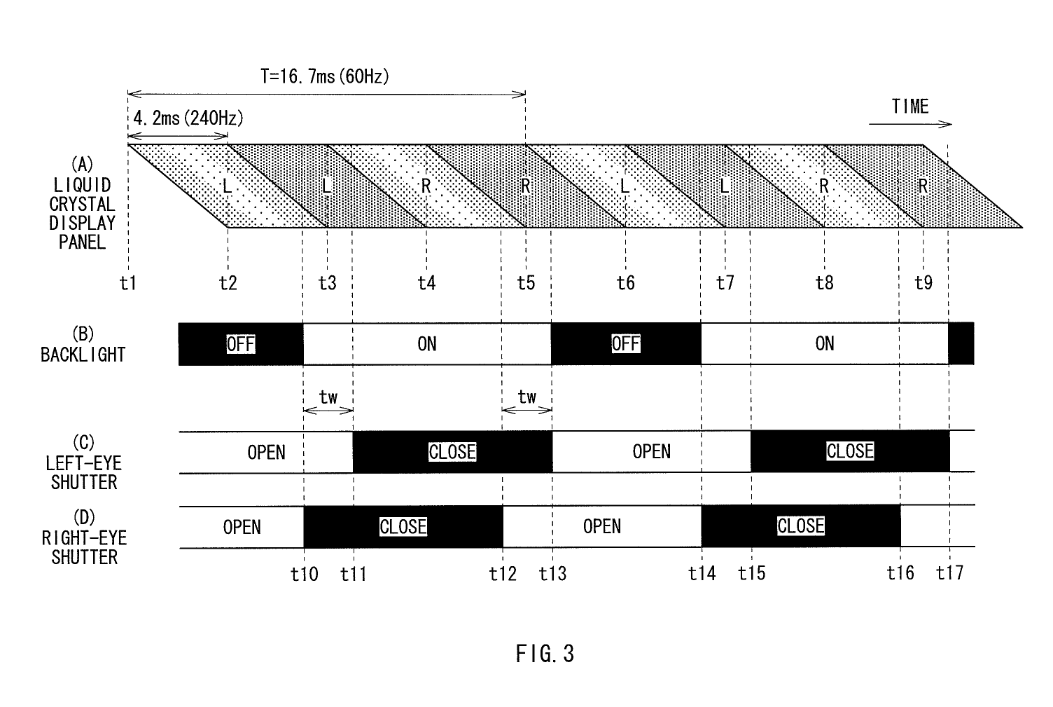

FIG. 3 illustrates a first modification of the first embodiment illustrated in (A) to (D) of FIG. 2, wherein, as in FIG. 2 according to the first embodiment, (A) schematically illustrates the response timing of the image displaying in the liquid crystal display panel 11, (B) schematically illustrates the lighting timing of the backlight 12, (C) schematically illustrates the opening-closing timing of the left-eye shutter 20L in the shutter eyeglasses 20, and (D) schematically illustrates the opening-closing timing of the right-eye shutter 20R.

In the first modification, the response timing of the liquid crystal display panel 11 illustrated in (A) of FIG. 3 is identical to that illustrated in (A) of FIG. 2. The opening-closing timings of the left-eye shutter 20L and the right-eye shutter 20R are reversal (a right-and-left contrary) to those illustrated in (C) and (D) of FIG. 2. The lighting timing of the backlight 12 is, corresponding to the opening-closing timings of the left-eye shutter 20L and the right-eye shutter 20R, also reversal (a right-and-left contrary) to that illustrated in (B) of FIG. 2.

As for the left-eye shutter 20L, in (C) of FIG. 2 of the first embodiment, the left-eye shutter 20L is in the open state in the period tw during which the observer is allowed to see the left-eye image L (i.e., allocated to the left-eye image L to be observed), and the left-eye shutter 20L is in the open state also during a successive predetermined period that is subsequent to the period tw. Also, the period tw for the left-eye shutter 20L in the first embodiment is provided immediately after a period during which the left-eye shutter 20L is in the closed state. In contrast, in (C) of FIG. 3 of the first modification, the left-eye shutter 20L is in the open state in the period tw during which the observer is allowed to see the left-eye image L, and the left-eye shutter 20L is in the open state also during a successive predetermined period that is previous to (precedes) the period tw. Also, the period tw for the left-eye shutter 20L in the first modification is provided immediately before a period during which the left-eye shutter 20L is in the closed state.

As for the right-eye shutter 20R, in (D) of FIG. 2 of the first embodiment, the right-eye shutter 20R is in the open state in the period tw during which the observer is allowed to see the right-eye image R (i.e., allocated to the right-eye image R to be observed), and the right-eye shutter 20R is in the open state also during a successive predetermined period that is previous to (precedes) the period tw. Also, the period tw for the right-eye shutter 20R in the first embodiment is provided immediately before a period during which the right-eye shutter 20R is in the closed state. In contrast, in (D) of FIG. 3 of the first modification, the right-eye shutter 20R is in the open state in the period tw during which the observer is allowed to see the right-eye image R, and the right-eye shutter 20R is in the open state also during a successive predetermined period that is subsequent to the period tw. Also, the period tw for the right-eye shutter 20R in the first modification is provided immediately after a period during which the right-eye shutter 20R is in the closed state.

The control performed in the first modification also exhibits effects similar to those according to the first embodiment illustrated in (A) to (D) of FIG. 2.

### Second Modification of First Embodiment

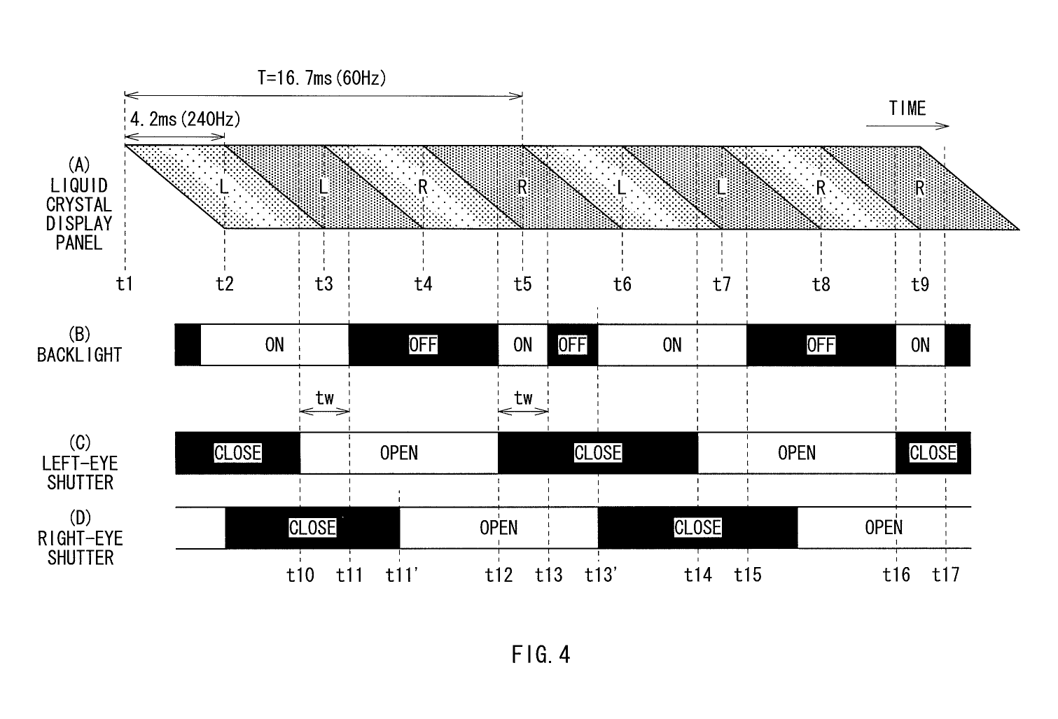

FIG. 4 illustrates a second modification of the first embodiment illustrated in (A) to (D) of FIG. 2, wherein, as in FIG. 2 according to the first embodiment, (A) schematically illustrates the response timing of image displaying in the liquid crystal display panel 11, (B) schematically illustrates the lighting timing of the backlight 12, (C) schematically illustrates the opening-closing timing of the left-eye shutter 20L in the shutter eyeglasses 20, and (D) schematically illustrates the opening-closing timing of the right-eye shutter 20R.

The response timing of the liquid crystal display panel 11 illustrated in (A) of FIG. 4 is identical to that illustrated in (A) of FIG. 2. In the second modification, the phase difference in the opening-closing timing between the left-eye shutter 20L and the right-eye shutter 20R differs from that according to the first embodiment illustrated in (A) to (D) of FIG. 2. In the first embodiment illustrated in (A) to (D) of FIG. 2, the phase difference is set for the period tw during which the left-eye image L or the right-eye image R is displayed throughout the entire liquid crystal display panel 11 (for example, 2.1 msec, i.e., a cycle of “T/8”), although the phase difference may be other than tw (T/8). In the stereoscopic display system according to the embodiment, it is possible to provide the period during which the left-eye shutter 20L and the right-eye shutter 20R are both in the closed state, as long as the phase difference is equal to or more than tw and less than T/2, and to increase the temperature of the liquid crystal display panel 11 by turning on the backlight 12 in that period.

The second modification illustrated in (A) to (D) of FIG. 4 is an example of the displaying where the phase difference is T/4. As compared with the first embodiment illustrated in (A) to (D) of FIG. 2, the second modification turns on the backlight 12 during the period in which both the left-eye shutter 20L and the right-eye shutter 20R are closed (for example, a period from the time t13′ to the time t14), thereby making it possible to increase the temperature of the liquid crystal display panel 11 more than that according to the second comparative example illustrated in (A) to (C) of FIG. 9.

### Second Embodiment

A stereoscopic display system according to a second embodiment of the technology will now be described.

The stereoscopic display system according to the second embodiment has a basic configuration which is similar to the configuration according to the first embodiment illustrated in FIG. 1. The stereoscopic display system of the second embodiment differs from that of the first embodiment, in that the control operations on respective timings including the blinking timing (the lighting timing) of the backlight 12 and the opening-closing timings of the shutter eyeglasses 20 differ partially from those according to the first embodiment described above.

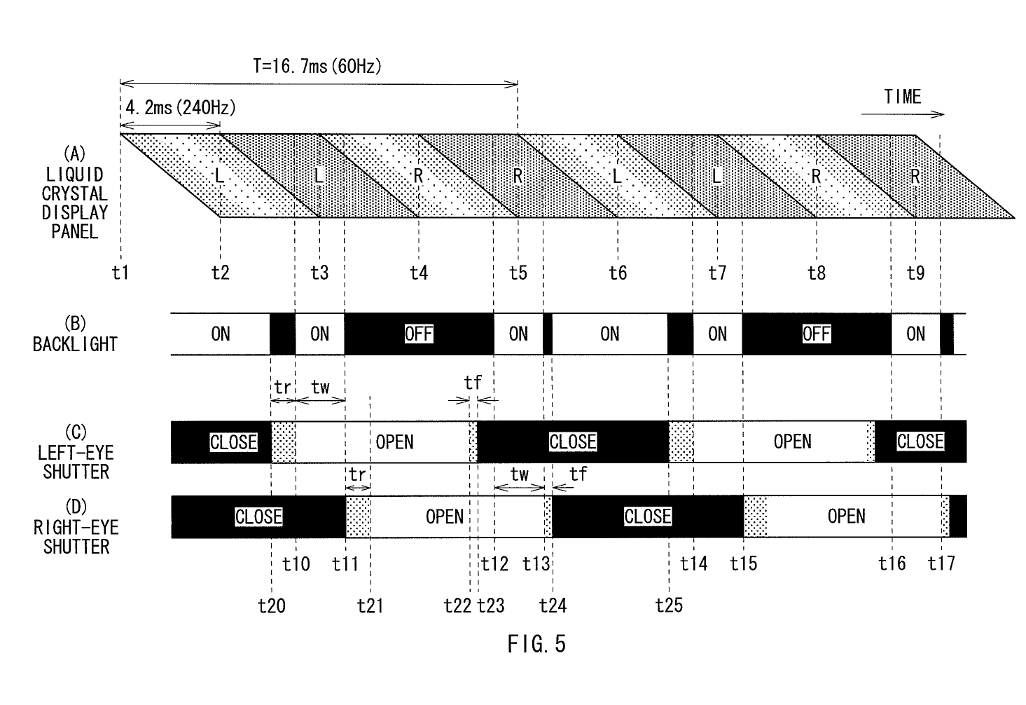

FIG. 5 illustrates timings of a displaying operation of the stereoscopic display system according to the second embodiment, wherein, as in FIG. 2 according to the first embodiment, (A) schematically illustrates the response timing of the image displaying in the liquid crystal display panel 11, (B) schematically illustrates the lighting timing of the backlight 12, (C) schematically illustrates the opening-closing timing of the left-eye shutter 20L in the shutter eyeglasses 20, and (D) schematically illustrates the opening-closing timing of the right-eye shutter 20R.

The first embodiment has been described with reference to a case where the transient characteristics at the time of the opening and the closing of the liquid crystal shutters in the shutter eyeglasses 20 are negligible. The second embodiment is a case in which the transient characteristics are considered. In a stereoscopic displaying scheme of a time-division type, the visual fatigue may be caused when brightness of the left-eye image and that of the right-eye image which the observer sees differ from one another. Hence, it is preferable that the left and the right images be seen by the observer with a state in which a transmittance of the left-eye shutter 20L and that of the right-eye shutter 20R are substantially equal to each other.

In the second embodiment, since the response timing of the liquid crystal display panel 11 illustrated in (A) of FIG. 5 is identical to that illustrated in (A) of FIG. 2, operations of the backlight 12 and the shutter eyeglasses 20 illustrated in (B) to (D) of FIG. 5 will be described particularly. Also, the control of turning on and off the backlight 12 is performed by the backlight control section 18, and the open/closed states of the shutter eyeglasses 20 are controlled by the shutter control section 17, as in the first embodiment.

Referring to (B) to (D) of FIG. 5, controls other than those performed on periods during which the transient characteristics at the time of the opening and the closing of the liquid crystal shutters in the shutter eyeglasses 20 deserve consideration, are similar to those illustrated in (B) to (D) of FIG. 2. The periods during which the transient characteristics deserve consideration include: a period for allowing the liquid crystal shutter to transit from the open state to the closed state; and a period for allowing the liquid crystal shutter to transit from the closed state to the open state.

In (C) of FIG. 5, a period from the time t20 to the time t10 indicates the rising time tr during which the left-eye shutter 20L transits from the closed state to the open state (for example, 1.4 msec), and a period from the time t22 to the time t23 indicates the falling time tf during which the left-eye shutter 20L transits from the open state to the closed state (for example, 0.1 msec), for example.

Similarly, in (D) of FIG. 5, a period from the time t11 to the time t21 indicates the rising time tr during which the right-eye shutter 20R transits from the closed state to the open state (for example, 1.4 msec), and a period from the time t13 to the time t24 indicates the falling time tf during which the right-eye shutter 20R transits from the open state to the closed state (for example, 0.1 msec), for example. In this embodiment, the rising time tr and the falling time tf may be equal between the left and right, since typically, the same shutter device is used for each of the left-eye shutter 20L and the right-eye shutter 20R.

The opening-closing timings of the liquid crystal shutters in this embodiment differ from those according to the first embodiment illustrated in (C) and (D) of FIG. 2, in that the time in which the left-eye shutter 20L starts to open and the time in which the left-eye shutter 20L starts to close are each earlier by an amount of time corresponding to the rising time tr of the shutter. It is to be noted here that the time in which the right-eye shutter 20R starts to open and the time in which the right-eye shutter 20R starts to close are both the same as the opening-closing timings illustrated in (C) and (D) of FIG. 2. In other words, a phase difference in the opening-closing timing between the left-eye shutter 20L and the right-eye shutter 20R is defined as “tr+tw”.

A control method of the backlight 12 in this embodiment is basically the same as that illustrated in (B) of FIG. 2, i.e., the backlight 12 is turned off during the period in which the left-eye shutter 20L and the right-eye shutter 20R are both open, and the backlight 12 is turned on during the period in which the left-eye shutter 20L and the right-eye shutter 20R are both closed. A difference in comparison to the operation timing illustrated in (B) of FIG. 2 is that the backlight 12 is turned off even during the rising time tr of the left-eye shutter 20L and during the falling time tf of the right-eye shutter 20R.

The timing controls of the backlight 12 and the shutter eyeglasses 20 according to the second embodiment described above make it possible to allow the observer to see the left and the right images with the state in which the transmittance of the left-eye shutter 20L and that of the right-eye shutter 20R are substantially equal to each other. Also, the proportion of time during which the backlight 12 is lighted is larger than that of the scheme according to the comparative example illustrated in FIG. 9 where the backlight is turned off in all of the periods in which the images are rewritten. Hence, it is possible to increase the temperature of the liquid crystal display panel 11, and to improve the responsiveness of the liquid crystals.

### First Modification of Second Embodiment

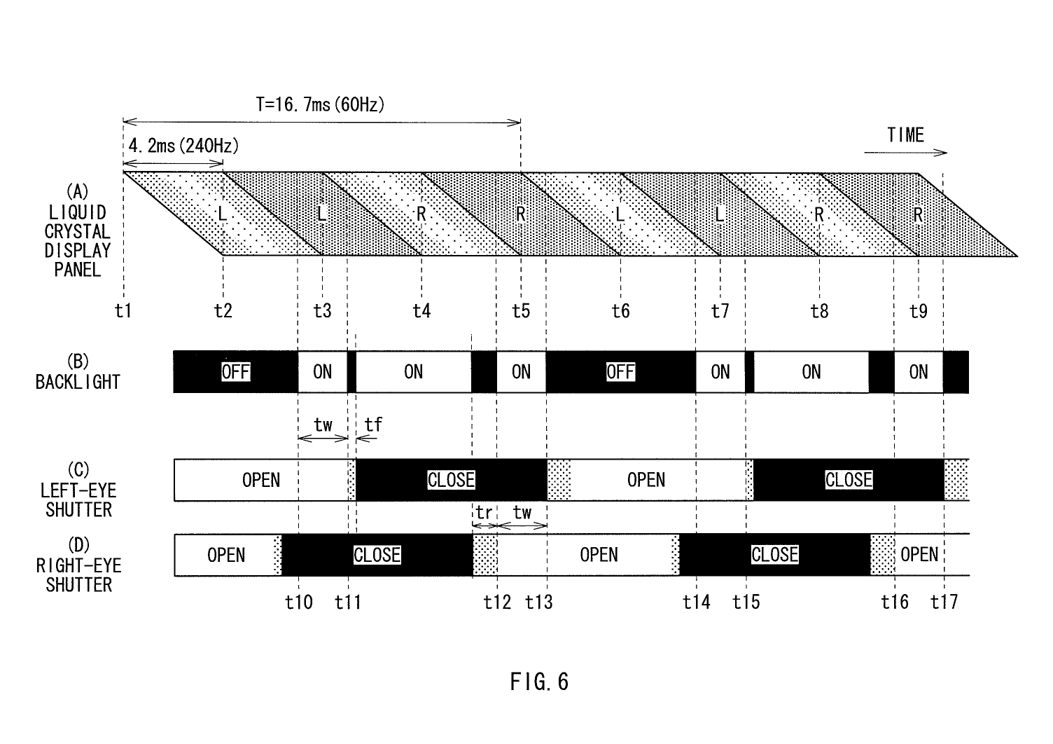

FIG. 6 illustrates a first modification of the second embodiment illustrated in (A) to (D) of FIG. 5, wherein, as in FIG. 5 according to the second embodiment, (A) schematically illustrates the response timing of the image displaying in the liquid crystal display panel 11, (B) schematically illustrates the lighting timing of the backlight 12, (C) schematically illustrates the opening-closing timing of the left-eye shutter 20L in the shutter eyeglasses 20, and (D) schematically illustrates the opening-closing timing of the right-eye shutter 20R.

In the first modification of the second embodiment, the response timing of the liquid crystal display panel 11 illustrated in (A) of FIG. 6 is identical to that illustrated in (A) of FIG. 5. The opening-closing timings of the left-eye shutter 20L and the right-eye shutter 20R are reversal (a right-and-left contrary) to those illustrated in (C) and (D) of FIG. 5. The lighting timing of the backlight 12 is, corresponding to the opening-closing timings of the left-eye shutter 20L and the right-eye shutter 20R, also reversal (a right-and-left contrary) to that illustrated in (B) of FIG. 5.

As for the left-eye shutter 20L, in (C) of FIG. 5 of the second embodiment, the left-eye shutter 20L is in the open state in the period tw during which the observer is allowed to see the left-eye image L, and the left-eye shutter 20L is in the open state also during a successive predetermined period that is subsequent to the period tw. Also, the period tw for the left-eye shutter 20L in the second embodiment is provided immediately after the period during which the left-eye shutter 20L has transited from the closed state to the open state. In contrast, in (C) of FIG. 6 of the first modification of the second embodiment, the left-eye shutter 20L is in the open state in the period tw during which the observer is allowed to see the left-eye image L, and the left-eye shutter 20L is in the open state also during a successive predetermined period that is previous to (precedes) the period tw. Also, the period tw for the left-eye shutter 20L in the first modification illustrated in (C) of FIG. 6 is provided immediately before the period during which the left-eye shutter 20L transits from the open state to the closed state.

As for the right-eye shutter 20R, in (D) of FIG. 5 of the second embodiment, the right-eye shutter 20R is in the open state in the period tw during which the observer is allowed to see the right-eye image R, and the right-eye shutter 20R is in the open state also during a successive predetermined period that is previous to (precedes) the period tw. Also, the period tw for the right-eye shutter 20R in the second embodiment is provided immediately before the period during which the right-eye shutter 20R transits from the open state to the closed state. In contrast, in (D) of FIG. 6 of the first modification of the second embodiment, the right-eye shutter 20R is in the open state in the period tw during which the observer is allowed to see the right-eye image R, and the right-eye shutter 20R is in the open state also during a successive predetermined period that is subsequent to the period tw. Also, the period tw for the right-eye shutter 20R in the first modification illustrated in (D) of FIG. 6 is provided immediately after the period during which the right-eye shutter 20R has transited from the closed state to the open state.

The control performed in the first modification of the second embodiment also exhibits effects similar to those according to the second embodiment illustrated in (A) to (D) of FIG. 5.

### Second Modification of Second Embodiment

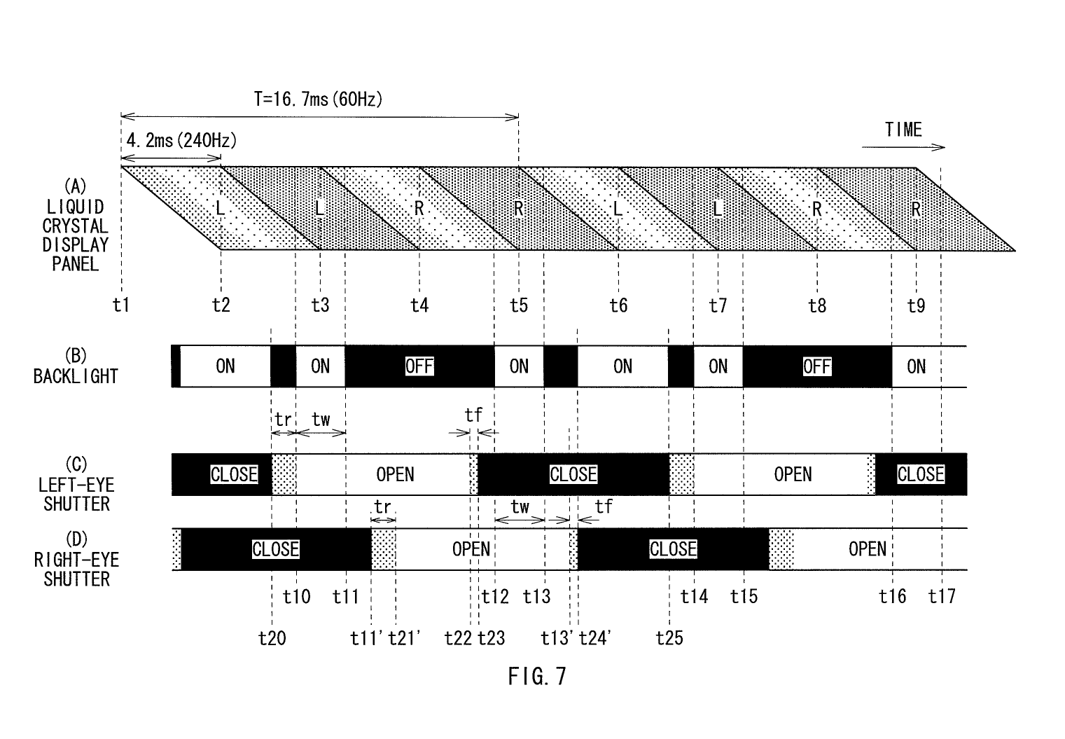

FIG. 7 illustrates a second modification of the second embodiment illustrated in (A) to (D) of FIG. 5, wherein, as in FIG. 5 according to the second embodiment, (A) schematically illustrates the response timing of image displaying in the liquid crystal display panel 11, (B) schematically illustrates the lighting timing of the backlight 12, (C) schematically illustrates the opening-closing timing of the left-eye shutter 20L in the shutter eyeglasses 20, and (D) schematically illustrates the opening-closing timing of the right-eye shutter 20R.

The response timing of the liquid crystal display panel 11 illustrated in (A) of FIG. 7 is identical to that illustrated in (A) of FIG. 5. In the second modification of the second embodiment, the phase difference in the opening-closing timing between the left-eye shutter 20L and the right-eye shutter 20R differs from that according to the second embodiment illustrated in (A) to (D) of FIG. 5. In the second embodiment illustrated in (A) to (D) of FIG. 5, the phase difference in the opening-closing timing between the left-eye shutter 20L and the right-eye shutter 20R is set to the period “tr+tw”, although the phase difference may be other than “tr+tw”. In the stereoscopic display system according to the embodiment, it is possible to provide the period during which the left-eye shutter 20L and the right-eye shutter 20R are both in the closed state, as long as the phase difference is equal to or more than “tr+tw” and less than “T/2−tf”, and to increase the temperature of the liquid crystal display panel 11 by turning on the backlight 12 in that period.

The second modification of the second embodiment illustrated in (A) to (D) of FIG. 7 is an example of the displaying where the phase difference is T/4. As compared with the second embodiment illustrated in (A) to (D) of FIG. 5, the second modification turns on the backlight 12 during the period in which both the left-eye shutter 20L and the right-eye shutter 20R are closed (for example, a period from the time t24′ to the time t25), thereby making it possible to increase the temperature of the liquid crystal display panel 11 more than that according to the second comparative example illustrated in (A) to (C) of FIG. 9.

### OTHER EMBODIMENTS

Although the technology has been described in the foregoing by way of example with reference to the embodiments and the modifications, the technology is not limited thereto but may be modified in a wide variety of ways.

In each of the embodiments and the modifications, the left-eye image and the right-eye image are each alternately displayed twice, although it is not limited thereto. The number of times the left-eye image or the right-eye image is displayed successively is not limited to twice, and may be three or more times. In one embodiment, a displaying operation may be performed in the liquid crystal display panel 11, in which the same left-eye image is displayed three times in succession, and then the same right-eye image is displayed three times in succession.

The present disclosure contains subject matter related to that disclosed in Japanese Priority Patent Application JP 2010-124615 filed in the Japan Patent Office on May 31, 2010, the entire content of which is hereby incorporated by reference.

Although the technology has been described in terms of exemplary embodiments, it is not limited thereto. It should be appreciated that variations may be made in the described embodiments by persons skilled in the art without departing from the scope of the technology as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

1. A stereoscopic display system comprising:
a display panel configured to display images;
a backlight irradiating light used to display images toward the display panel;
shutter eyeglasses including a left-eye shutter and a right-eye shutter that are controlled to be opened and closed independently of each other;
a display control section configured to allow the display panel to alternately display a left-eye image and a right-eye image in a time-divisional fashion;
a backlight control section configured to control the backlight to be on and off; and
a shutter control section configured to control the left-eye shutter and the right-eye shutter to open and close in accordance with an image displayed on the display panel,
wherein the shutter control section is configured to allow the left-eye and right-eye shutters to establish a first period in which the left-eye and right-eye shutters both are open or closed, and
the backlight control section is configured to allow the backlight to be off at least during the first period.

2. The stereoscopic display system according to claim 1, wherein the display control section is configured to allow the display panel to display the image constantly during a period including the first period, whether the left-eye and right-eye shutters are open or closed.

3. The stereoscopic display system according to claim 1, wherein the backlight control section is configured to allow the backlight to be on at least during a period in which the left-eye and right-eye shutters both are closed.

4. The stereoscopic display system according to claim 1, wherein the display control section is configured to allow the display panel to display a plurality of successive left-eye images which are the same and a plurality of successive right-eye images, which are the same, the successive left-eye images and the successive right-eye images being alternately displayed.

5. The stereoscopic display system according to claim 3,
wherein the shutter control section is configured to allow the left and right-eye shutters to be open and closed in accordance with the image displayed on the display panel, to establish a second period in which only the left-eye shutter is open and a third period in which only the right-eye shutter is open, as well as the first period, and
the backlight control section is configured to allow the backlight to be on during the second and third periods as well.

6. The stereoscopic display system according to claim 1,
wherein the shutter control section is configured to allow the left-eye shutter to open during a period allocated to the left-eye image to be observed and also during a predetermined preceding or subsequent period thereto, and allows the right-eye shutter to open during a period allocated to the right-eye image to be observed and also during a predetermined preceding or subsequent period thereto.

7. The stereoscopic display system according to claim 1, wherein the shutter control section is configured to allow the left and right-eye shutters to open and close, to allow a phase difference in an opening-closing timing between the left-eye shutter and the right-eye shutter to be equal to or more than tw and less than T/2, where T is a time interval of displaying the left-eye image or the right-eye image on the display panel, and tw is a length of a period allocated to the left-eye image or the right-eye image to be observed.

8. The stereoscopic display system according to claim 1, wherein the shutter control section is configured to allow the left and right-eye shutters to open and close, to allow a phase difference in an opening-closing timing between the left-eye shutter and the right-eye shutter to be equal to or more than tr+tw and less than T/2−tf, where tr is a rising time required for a transition from closed state to open state in the left-eye shutter or the right-eye shutter, and tf is a falling time required for a transition from closed state to open state in the left-eye shutter or the right-eye shutter.

9. The stereoscopic display system according to claim 8, wherein the backlight control section is configured to allow the backlight to be off also during a period of the rising time tr of one of the left-eye and right-eye shutters, the one being accompanied with a more-advanced phase of the opening-closing timing.

10. The stereoscopic display system according to claim 8, wherein the backlight control section is configured to allow the backlight to be off also during a period of the falling time tf of one of the left-eye and right-eye shutters, the one being accompanied with a more-delayed phase of the opening-closing timing.

11. A stereoscopic display system comprising:
a display panel configured to display images;
a backlight irradiating light used for the image displaying toward the display panel; and
shutter eyeglasses including a left-eye shutter and a right-eye shutter that are controlled to be opened and closed,
wherein the left-eye and right-eye shutters are configured to establish a period in which the left-eye and right-eye shutters both are open, and
the backlight is turned off during the period in which the left-eye and right-eye shutters both are open.

12. The stereoscopic display system according to claim 11, wherein the display panel is configured to display an image constantly during a period including the period in which the left-eye and right-eye shutters both are open, whether the left-eye and right-eye shutters are open or closed.

13. A stereoscopic display system comprising:
a display panel;
a backlight; and
shutter eyeglasses including a left-eye shutter and a right-eye shutter,
wherein the backlight is off during a period in which the left-eye and right-eye shutters both are open.

14. A stereoscopic display system comprising:
a display panel;
a backlight; and
shutter eyeglasses including a left-eye shutter and a right-eye shutter,
wherein the backlight is on during a period in which the left-eye and right-eye shutters both are closed.
